(19) United States
(12) Patent Application Publication
(10) Pub. No.: US 2026/0339373 A1
(43) Pub. Date: Oct. 29, 2026

(54) ENERGY STORAGE MODULE, POWER SUPPLY SYSTEM, AND METHOD OF CONTROLLING THE ENERGY STORAGE MODULE

(71) Applicant: DELTA ELECTRONICS (THAILAND) PUBLIC COMPANY LIMITED, Amphur Muang (TH)

(72) Inventors: Min XU, Shanghai (CN); Yuming MA, Shanghai (CN); Kai WANG, Shanghai (CN); Wenmao WU, Shanghai (CN)

(21) Appl. No.: 19/343,608

(22) Filed: Sep. 29, 2025

(30) Foreign Application Priority Data
Apr. 23, 2025 (CN) 202510523506.9

(51) Int. Cl. G05F 1/62; G05F 1/565; G05F 1/613; H02J 7/00; H02J 7/61; H02J 7/63; H02M 3/158

(52) U.S. Cl. CPC G05F 1/62; G05F 1/565; G05F 1/613; H02J 7/61; H02J 7/63; H02J 7/855; H02M 3/1582

(57) ABSTRACT

An energy storage module, a power supply system, and a method of controlling the energy storage module are disclosed. The energy storage module includes a bidirectional DC-to-DC converter and an energy storage unit. A first terminal of the bidirectional DC-to-DC converter is connected to the energy storage unit. The method includes: adjusting a reference signal according to a compensation signal, and acquiring a current reference signal corresponding to the bidirectional DC-to-DC converter according to the adjusted reference signal and a current-sharing bus signal provided by a power module connected to a second terminal of the bidirectional DC-to-DC converter to control an operation state of the energy storage module.

### BACKGROUND

### Technical Field

The present disclosure relates to a field of power supplies, and more particularly to an energy storage module, a power supply system, and a method of controlling the energy storage module.

### Description of Related Art

The statements in this section merely provide background information related to the present disclosure and do not necessarily constitute prior art.

In applications of server power supplies, the common structure of the power module (also referred to as “power supply unit”, PSU) is a two-stage topology: the front stage is a power factor correction circuit (PFC), and the rear stage is a direct-current to direct-current (DC-to-DC) converter.

With the development of AI (artificial intelligence) and high-performance computing, the power consumption of components such as graphics processing units (GPUs) and central processing units (CPUs) in servers is also increasing. As the demand for high-performance computing increases, server power supply systems need to cope with higher power requirements, higher heat dissipation capabilities, and more stable voltage control requirements, and require more intelligent power management systems to ensure their stable operation. Since AI (artificial intelligence) loads frequently experience large fluctuations, the output power of the server power supply fluctuates dramatically. Therefore, discontinuities in the AC input waveform may introduce undesired noise into the power supply network, thereby impacting the power quality on the input side.

In the prior art, energy storage modules such as capacitors are used to compensate for the fluctuations of input current and achieve the effect of peak shaving and valley filling. When the voltage of the energy storage unit (such as capacitor unit) in the energy storage module is charged to a value close to the maximum threshold, the usual practice is to limit its charging power, but no additional control is applied to discharging. At this time, it is desirable for the energy storage unit to charge less during charging period and to discharge more during discharging period. Similarly, when the voltage of the energy storage unit is close to the minimum threshold, it is usually limited its further discharge, but no additional control is applied to charging. At this time, it is desirable for the energy storage unit to discharge less during discharging period and to charge more during charging period.

Therefore, how to design an energy storage module, a power supply system, and a method of controlling the energy storage module, to compensate for fluctuations in the input current and meanwhile to achieve less charging and more discharging when the voltage of the energy storage unit approaches the maximum threshold, and less discharging and more charging when the voltage of the energy storage unit approaches the minimum threshold has become a critical topic in this field.

### SUMMARY

An objective of the present disclosure is to provide a method of controlling an energy storage module to solve the problems of existing technologies.

In order to achieve the above-mentioned objective, the energy storage module includes a bidirectional DC-to-DC converter and an energy storage unit. A first terminal of the bidirectional DC-to-DC converter is connected to the energy storage unit. The method includes: adjusting a reference signal according to a compensation signal, and acquiring a current reference signal corresponding to the bidirectional DC-to-DC converter according to the adjusted reference signal and a current-sharing bus signal provided by a power module connected to a second terminal of the bidirectional DC-to-DC converter to control an operation state of the energy storage module, wherein the compensation signal is determined by a voltage of the energy storage unit.

In one embodiment, the method further includes: when the voltage of the energy storage unit is greater than a high voltage threshold, the compensation signal is a positive value; when the voltage of the energy storage unit is less than a low voltage threshold, the compensation signal is a negative value.

In one embodiment, the method further includes: acquiring the adjusted reference signal based on a difference between the compensation signal and the reference signal.

In one embodiment, the compensation signal is positively correlated with the voltage of the energy storage unit.

In one embodiment, when the voltage of the energy storage unit is between the low voltage threshold and the high voltage threshold, the compensation signal is zero.

In one embodiment, when the voltage of the energy storage unit is between the low voltage threshold and the high voltage threshold, the compensation signal is positively correlated with the voltage of the energy storage unit.

In one embodiment, a change rate of the compensation signal with respect to the voltage of the energy storage unit when the voltage of the energy storage unit is between the low voltage threshold and the high voltage threshold is less than a change rate of the compensation signal with respect to the voltage of the energy storage unit when the voltage of the energy storage unit is greater than the high voltage threshold or less than the low voltage threshold.

In one embodiment, the compensation signal is linearly related to the voltage of the energy storage unit.

In one embodiment, the method further includes: configuring the adjusted reference signal to decrease to be zero when the voltage of the energy storage unit is greater than the high voltage threshold and continuously to increase to reach a second high voltage threshold, such that the energy storage module exits a charging mode.

In one embodiment, the method further includes: configuring the adjusted reference signal to increase to be equal to a rated value of a current-sharing bus sampling signal when the voltage of the energy storage unit is less than the low voltage threshold and continuously to decrease to reach a second low voltage threshold, such that the energy storage module exits a discharging mode, wherein the current-sharing bus sampling signal is acquired by sampling the current-sharing bus signal, and the rated value of the current-sharing bus sampling signal represents an output current of the power module at rated power.

In one embodiment, the reference signal represents an average power of the power module.

In one embodiment, the reference signal is determined by the current-sharing bus signal.

In one embodiment, the method further includes: generating a control signal to control the bidirectional DC-to-DC converter according to the current reference signal and an inductor current sampling signal of the bidirectional DC-to-DC converter.

In one embodiment, the method further includes: acquiring a current-sharing bus sampling signal by sampling the current-sharing bus signal; controlling the energy storage module to operate in a discharging mode so that the energy storage unit discharges to a load of the power module when the current-sharing bus sampling signal is greater than a difference between the reference signal and the compensation signal; controlling the energy storage module to operate in a charging mode so that the energy storage unit stores energy when the current-sharing bus sampling signal is less than the difference between the reference signal and the compensation signal, thereby compensating for fluctuations of the input current of the power module.

Another objective of the present disclosure is to provide an energy storage module to solve the problems of existing technologies.

In order to achieve the above-mentioned objective, the energy storage module includes a bidirectional DC-to-DC converter and an energy storage unit. A first terminal of the bidirectional DC-to-DC converter is connected to the energy storage unit, and a second terminal of the bidirectional DC-to-DC converter is connected to an output terminal of a power module; each energy storage module further includes a controller, and the controller configured to execute the above-mentioned method.

Further another objective of the present disclosure is to provide a power supply system to solve the problems of existing technologies.

In order to achieve the above-mentioned objective, the power supply system includes at least one power module and at least one energy storage module. An output terminal of each power module is connected in parallel to a load, wherein each power module converts its own output current into a voltage signal to a current-sharing bus. An output terminal of each energy storage module is connected together, and each energy storage module includes a bidirectional DC-to-DC converter and an energy storage unit. A first terminal of the bidirectional DC-to-DC converter is connected to the energy storage unit, and a second terminal of the bidirectional DC-to-DC converter is connected to the output terminal of the power module. Each energy storage module further includes a controller, and the controller executes the above-mentioned method; wherein the voltage signal on the current-sharing bus is the current-sharing bus signal.

In one embodiment, the at least one power module is disposed in the same power shelf.

In one embodiment, the at least one energy storage module is disposed in the same power shelf.

Accordingly, the present disclosure has the following features and advantages: based on less charging and more discharging when the energy storage module approaches the high voltage threshold to prevent overcharging, and based on less discharging and more charging when the energy storage module approaches the low voltage threshold to prevent over-discharging.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a block circuit diagram of a power supply system including a power module and an energy storage module according to the present disclosure.

FIG. 2 is a circuit diagram of the energy storage module according to the present disclosure.

FIG. 3 is a schematic block diagram of a single power module and a single energy storage module according to the present disclosure.

FIG. 4 is a schematic block diagram of multiple power modules and multiple energy storage modules according to the present disclosure.

FIG. 5 is a block diagram of a control loop of an energy storage unit according to the present disclosure.

FIG. 6 is a schematic diagram of a relationship between a compensation signal and a voltage of the energy storage unit according to an embodiment of the present disclosure.

FIG. 7 is a schematic diagram of a relationship between the compensation signal and the voltage of the energy storage unit according to another embodiment of the present disclosure.

FIG. 8 is a schematic diagram of a principle of setting the compensation signal according to the present disclosure.

FIG. 9 is a flowchart of a method of controlling the energy storage module according to the present disclosure.

### DETAILED DESCRIPTION

Reference will now be made to the drawing figures to describe the present disclosure in detail. It will be understood that the drawing figures and exemplified embodiments of present disclosure are not limited to the details thereof.

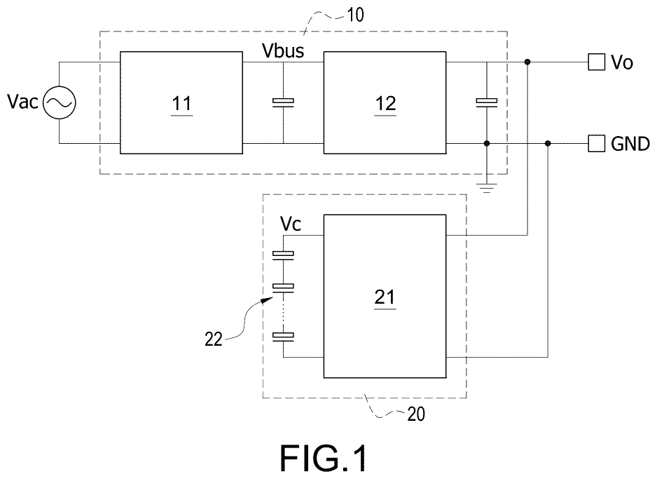

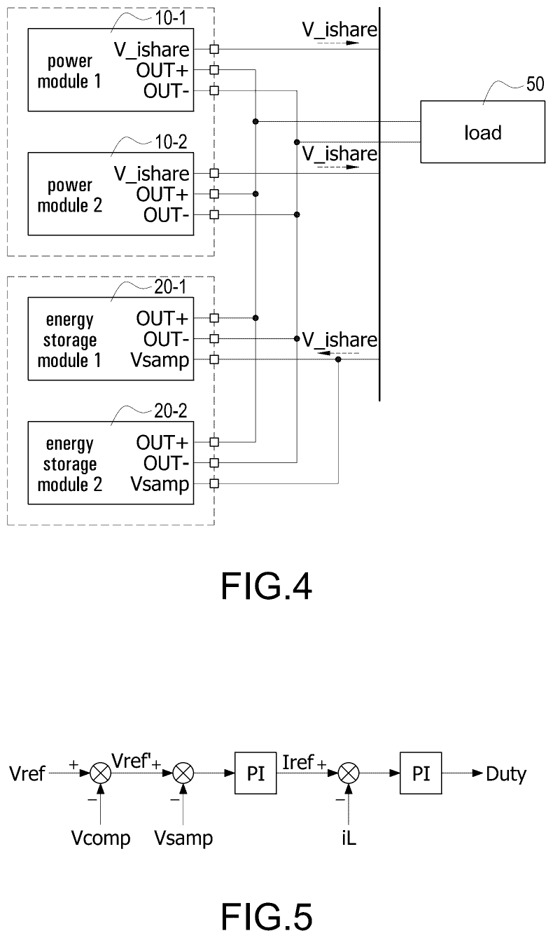

Please refer to FIG. 1, which shows a block circuit diagram of a power supply system having a power module combined with an energy storage module according to the present disclosure. The power supply system includes at least one power module (also referred to as “power supply unit”, PSU) 10 and at least one energy storage module 20. The power module 10 includes, for example but not limited to, a front-stage power factor correction circuit (PFC) 11 and a rear-stage direct-current to direct-current (DC-to-DC) converter 12. The front-stage power factor correction circuit (PFC) 11 receives an alternating-current (AC) power source Vac, and converts the AC power source Vac into a DC power source. The DC power source is then converted by the rear-stage DC-to-DC converter 12 to be output. In particular, an output side of the rear-stage DC-to-DC converter 12 is connected to a load 50 (may be referred in FIG. 3 or FIG. 4) to supply power to the load 50. In some embodiment, the rear-stage DC-to-DC converter 12 may also be a single-stage AC-to-DC converter.

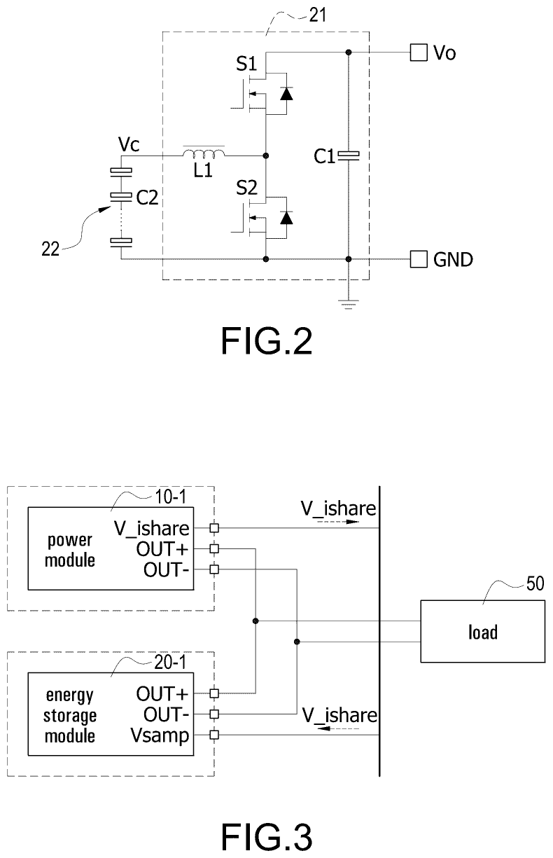

The energy storage module 20 mainly includes a bidirectional DC-to-DC converter 21 and an energy storage unit 22. The bidirectional DC-to-DC converter 21 may have many structures. The present disclosure is described by taking a common bidirectional buck/boost converter as an example, but the present disclosure is not limited thereto. Similarly, the energy storage unit 22 may be implemented by many energy storage components with energy storage function. The present disclosure is described by taking the energy storage component as the energy storage capacitor C2 (may be referred in FIG. 2) as an example, but the present disclosure is not limited thereto. In addition, the energy storage capacitor C2 may be, for example, a supercapacitor.

Specifically, each energy storage module 20 includes a bidirectional DC-to-DC converter 21 and an energy storage unit 22. A first terminal of the bidirectional DC-to-DC converter 21 is connected to the energy storage unit 22. A second terminal of the bidirectional DC-to-DC converter 21 is connected to the output terminal of the power module 10. Each energy storage module 20 further includes a controller, and the controller is used to control the energy storage module 20.

Specifically, if the load 50 is too heavy and without the energy storage module 20, an input current of the power module 10 will be too high. When the energy storage module 20 is added, the energy storage module 20 is controlled to operate in a discharging mode, so that the energy storage unit 22 releases energy to the load 50 through the bidirectional DC-to-DC converter 21, and supplies power to the load 50 together with the power module 10, thereby maintaining the input current of the power module 10 unchanged. On the contrary, when the load 50 is too light, the energy storage module 20 is controlled to operate in a charging mode so that the excess input power is delivered to the energy storage unit 22 through the bidirectional DC-to-DC converter 21 to charge the energy storage unit 22, thereby maintaining the input current of the power module 10 unchanged. Therefore, by providing or receiving current through the energy storage module 20, the output current of the power module 10 does not need to rapidly increase or decrease in a short period of time. As a result, the power module 10 does not need to quickly increase or decrease the current drawn from its input power source so that the input current of the power module 10 can be maintained unchanged, thereby reducing the impact on the power grid.

Please refer to FIG. 2, which shows a circuit diagram of the energy storage module according to the present disclosure. As mentioned above, the bidirectional DC-to-DC converter 21 of the energy storage module 20 is described by taking a bidirectional buck/boost converter as an example. The bidirectional DC-to-DC converter 21 includes an inductor L1, a first switch S1, a second switch S2, and a capacitor C1. When the energy storage module 20 operates in the discharging mode, the bidirectional DC-to-DC converter 21 operates in a boost state; when the energy storage module 20 operates in the charging mode, the bidirectional DC-to-DC converter 21 operates in a buck state. It should be noted that, in other embodiments, the opposite situation may also occur, which depends on the configuration of the energy storage unit 22.

Please refer to FIG. 3, which shows a schematic block diagram of a single power module and a single energy storage module according to the present disclosure. The power module 10-1 correspondingly converts its own output current into a voltage signal and connects it to the current-sharing bus. The voltage signal on the current-sharing bus is referred to as a current-sharing bus signal V_ishare. For example, according to the specification requirements of ORV3 (Open Rack Standard V3 or Open Compute Project Rack Standard V3), when the power module 10-1 generates 50% of the rated current, the current-sharing bus signal Vi_ishare is 3.5 volts; when the power module 10-1 generates 100% of the rated current, the current-sharing bus signal V_ishare is 7 volts. The energy storage module 20-1 can acquire the corresponding load information by simply sampling the current-sharing bus signal V_ishare on the current-sharing bus. In general, the current-sharing bus signal V_ishare is a signal that is positively correlated with the current value of the output current of the power module 10-1 so that the energy storage module 20-1 can estimate the condition of the load 50 according to the current-sharing bus signal V_ishare provided by the power module 10-1. For example, when the signal value of the current-sharing bus signal V_ishare is large, it represents that the load 50 needs more power. On the contrary, when the signal value of the current-sharing bus signal V_ishare is small, it represents that the load 50 needs less power. When a change rate of the signal value of the current-sharing bus signal V_ishare is large, it represents that the load 50 rapidly increases or decreases. Therefore, by utilizing the current-sharing bus signal V_ishare, there is no need to use additional devices to sample the output current of the power module 10-1 to acquire the load information. Usually, since the power module 10-1 is a packaged whole and no position is reserved for current sampling, the load information is cleverly acquired by utilizing the existing information of the power module 10-1.

Please refer to FIG. 4, which shows a schematic block diagram of multiple power modules and multiple energy storage modules according to the present disclosure. Compared with the single power module 10-1 and the single energy storage module 20-1 shown in FIG. 3, FIG. 4 illustrates that multiple (i.e., two) power modules 10-1,10-2 in parallel and multiple (i.e., two) energy storage modules 20-1,20-2 in parallel operate in coordination. In the parallel power module structure, output terminals of each power module are connected together to the load 50, and output terminals of each energy storage module are connected together to the output terminals of each power module. Also, each power module 10-1,10-2 will convert its own output current into a corresponding voltage signal, and multiple voltage signals will be connected to a common current-sharing bus. In general, for a system with multiple power modules connected in parallel, there is usually a requirement for current sharing, and therefore each power module 10-1,10-2 will compare its own output current with the current-sharing bus signal V_ishare on the common current-sharing bus to make corresponding adjustments to achieve the purpose of current sharing. For example, if the voltage signal corresponding to the output current of the power module 10-1 is lower than the current-sharing bus signal V_ishare on the current-sharing bus, it represents that the current supplied by the power module 10-1 is less. In this condition, the control circuit will control the power module 10-1 to generate more power to increase its output current, and vice versa. Therefore, the currents output by the power modules 10-1,10-2 tend to be the same to achieve the purpose of current sharing, thereby realizing load sharing, that is, the current-sharing bus signal V_ishare may represent the average load information of multiple power modules.

Furthermore, by the coordinated operation of the two energy storage modules 20-1,20-2 and the two power modules 10-1,10-2, when the load 50 is too heavy, the energy storage modules 20-1,20-2 are controlled to operate in the discharging mode to release energy to the load 50; alternatively, when the load 50 is too light, the energy storage modules 20-1,20-2 are controlled to operate in the charging mode so that the excess input power charges the energy storage units 22 of the energy storage modules 20-1,20-2, thereby maintaining the input currents of the power modules 10-1,10-2 unchanged. In addition, although two power modules and two energy storage modules are used as an example for explanation, it should be understood that the number of power modules and the number of energy storage modules are not in a one-to-one correspondence, and both can be designed according to the requirements of the load 50.

In other embodiments, multiple power modules are connected in parallel and placed in the same power shelf, and multiple energy storage modules are connected in parallel and placed in the same power shelf, and both are placed in a power rack.

Please refer to FIG. 9, which shows a flowchart of a method of controlling the energy storage module according to the present disclosure, and also refer to FIG. 5, which shows a block diagram of a control loop of the energy storage module according to the present disclosure. The method of controlling the energy storage module includes: first, a reference signal Vref is adjusted according to a compensation signal Vcomp (step S10). In particular, the compensation signal Vcomp is determined by a voltage Vc of the energy storage unit 22. Specifically, an adjusted reference signal Vref is acquired based on a difference between the compensation signal Vcomp from the reference signal Vref (that is, by subtracting the compensation signal Vcomp from the reference signal Vref).

Please refer to FIG. 9 again, after step S10, a current reference signal Iref corresponding to the bidirectional DC-to-DC converter 21 is acquired according to the adjusted reference signal (i.e., Vref−Vcomp) and the current-sharing bus signal V_ishare provided by the power module 10 (step S20) to control an operation state of the energy storage module (step S30).

Please refer to FIG. 5, which shows a block diagram of a control loop of an energy storage module according to the present disclosure. The adjusted reference signal Vref′ is acquired by subtracting the compensation signal Vcomp from the reference signal Vref. The current-sharing bus sampling signal Vsamp is acquired by sampling the current-sharing bus signal V_ishare. The operation state of the energy storage module 20 is controlled according a difference between the adjusted reference signal Vref′ and the current-sharing bus sampling signal Vsamp. In particular, the rated value of the current-sharing bus sampling signal Vsamp represents the output current of the power module 10 at rated power. In addition, when the energy storage module 20 is in a standby mode, that is, the pre-charging process of the energy storage module 20 has been completed, the energy storage module 20 is in a chargeable and dischargeable state, ready to compensate for changes in the input current at any time. Therefore, in the present disclosure, the reference signal Vref represents an average power generated by the power module 10, and the reference signal Vref is acquired by processing the current-sharing bus signal V_ishare. It should be understood that there are many manners to acquire the above reference signal Vref, for example, the reference signal Vref is an average value of the current-sharing bus sampling signal Vsamp over a period of time. Alternatively, the reference signal Vref is a value acquired by filtering the current-sharing bus sampling signal Vsamp, and the present disclosure does not limit this.

Specifically, a difference between the adjusted reference signal Vref′ and the current-sharing bus sampling signal Vsamp is compensated (for example but not limited to, by a PI controller) to generate a current reference signal Iref corresponding to the bidirectional DC-to-DC converter 21. Furthermore, an error acquired by the difference between the current reference signal Iref and the inductor current sampling signal iL is compensated (for example but not limited to, by a PI controller) to finally generate a control signal Duty to control a duty cycle of switches in the bidirectional DC-to-DC converter 21.

In some embodiments, the charging mode and the discharging mode of the energy storage module 20 can be implemented by using the same control loop, namely the control loop shown in FIG. 5. When the current reference signal Iref is greater than zero, the inductor current sampling signal iL is greater than zero, and the energy storage module 20 enters the charging mode; when the current reference signal Iref is less than zero, the inductor current sampling signal iL is less than zero, and the energy storage module 20 enters the discharging mode. In other embodiments, the charging mode and the discharging mode of the energy storage module 20 may also be implemented by two control loops. The control loop of the charging mode may be implemented as the control loop of FIG. 5. The control loop of the discharging mode may exchange the position of the current-sharing bus sampling signal Vsamp and the adjusted reference signal Vref′, that is, an error is acquired by subtracting the adjusted reference signal Vref from the current-sharing bus sampling signal Vsamp and then the error is compensated to acquire the current reference signal Iref to ensure that the current reference signal Iref is always greater than zero. Regardless of which of the above control loops is adopted, when the current-sharing bus sampling signal Vsamp is greater than the difference between the reference signal Vref and the compensation signal Vcomp (i.e., Vsamp>Vref−Vcomp), the energy storage module 20 is controlled to operate in the discharging mode so that the energy storage unit 22 discharges to the load of the power module 10. When the current-sharing bus sampling signal Vsamp is less than the difference between the reference signal Vref and the compensation signal Vcomp (i.e., Vsamp<Vref−Vcomp), the energy storage module 20 is controlled to operate in the charging mode so that the power module 10 stores energy in the energy storage unit 22, thereby compensating for the fluctuations of the input current of the power module 10.

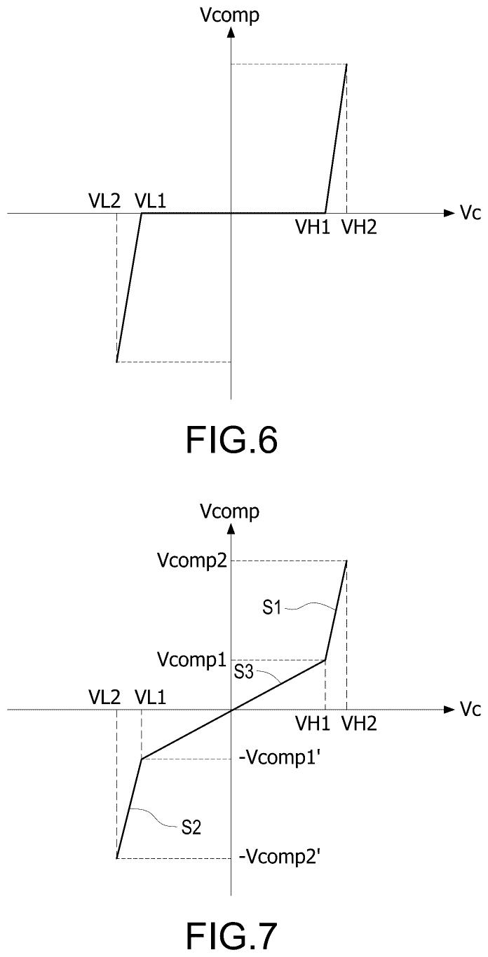

In the present disclosure, two embodiments of determining the compensation signal Vcomp according to the voltage Vc of the energy storage unit 22 are mainly proposed. The first embodiment is shown in FIG. 6, which is a schematic diagram of a relationship between a compensation signal and a voltage of the energy storage unit according to an embodiment of the present disclosure. Specifically, when the voltage Vc of the energy storage unit 22 is greater than the high voltage threshold VH1, the compensation signal Vcomp is a positive value; when the voltage Vc of the energy storage unit 22 is less than the low voltage threshold VL1, the compensation signal Vcomp is a negative value. Specifically, when the voltage Vc of the energy storage unit 22 is greater than the high voltage threshold VH1, the compensation signal Vcomp is positively correlated with the voltage Vc of the energy storage unit 22, that is, the compensation signal Vcomp increases with the increase of the voltage Vc of the energy storage unit 22. Furthermore, the compensation signal Vcomp and the voltage Vc of the energy storage unit 22 may be in a linear relationship. Similarly, when the voltage Vc of the energy storage unit 22 is less than the low voltage threshold VL1, the compensation signal Vcomp is positively correlated with the voltage Vc of the energy storage unit 22, that is, the compensation signal Vcomp decreases with the decrease of the voltage Vc of the energy storage unit 22. Furthermore, the compensation signal Vcomp and the voltage Vc of the energy storage unit 22 may be in a linear relationship.

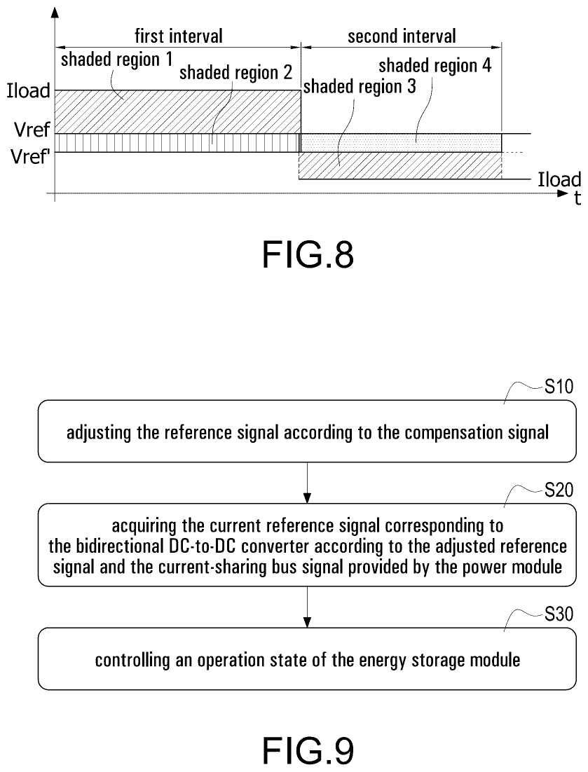

The principle of setting the compensation signal Vcomp will be further described below with reference to FIG. 8. An explanation is provided using the example where the voltage Vc of the energy storage unit 22 is greater than the high voltage threshold VH1. When the voltage Vc of the energy storage unit 22 reaches the high voltage threshold VH1, it represents that the energy storage unit 22 is about to be fully charged. If the energy storage module 20 is in the charging mode at this time, the energy storage unit 22 is easily overcharged, that is, the voltage Vc of the energy storage unit 22 may easily exceed the maximum limit, which is undesirable. If the energy storage module 20 is in the discharging mode at this time, the energy storage unit 22 is discharged normally, but since the energy storage unit 22 has a large amount of energy at this time, it is of course desirable for it to release more energy. Therefore, when the voltage Vc of the energy storage unit 22 reaches the high voltage threshold VH1, less charging and more discharging of the energy storage unit 22 is achieved by using the compensation signal Vcomp.

As shown in FIG. 8, the load current Iload changes dynamically. In the first interval, the load suddenly increases, and the energy storage module 20 is in the discharging mode. Without the compensation signal Vcomp, the energy released by the energy storage module 20 corresponds to the area represented by shaded region 1. After the compensation signal Vcomp is added, since the voltage Vc of the energy storage unit 22 is greater than the high voltage threshold VH1, the compensation signal Vcomp is a positive value. Therefore, the adjusted reference signal Vref acquired by subtracting the compensation signal Vcomp from the reference signal Vref is less than the reference signal Vref, that is, the adjusted reference signal Vref is smaller compared to the reference signal Vref before the adjustment. Therefore, the energy released by the energy storage module 20 increases as represented by shaded region 2, that is, the energy storage module 20 discharges more than before the compensation. Moreover, when the voltage Vc of the energy storage unit 22 is larger, the compensation signal Vcomp will be larger, and thus the adjusted reference signal Vref will be smaller, which leads to more discharge.

Correspondingly, in the second interval, the load suddenly decreases, and the energy storage module 20 is in the charging mode. Without the compensation signal Vcomp, the energy stored in the energy storage module 20 corresponds to the area represented by shaded region 3 plus the area represented by shaded region 4. After the compensation signal Vcomp is added, the compensation signal Vcomp is also a positive value. Therefore, the adjusted reference signal Vref acquired by subtracting the compensation signal Vcomp from the reference signal Vref is less than the reference signal Vref, that is, the adjusted reference signal Vref is smaller compared to the reference signal Vref before the adjustment. Therefore, after the compensation, the energy stored in the energy storage module 20 is only as shown by the area represented by shaded region 3, reducing the area represented by shaded region 4, that is, the energy storage module 20 charges less than before the compensation. Moreover, when the voltage Vc of the energy storage unit 22 is larger, the compensation signal Vcomp will be larger, and the adjusted reference signal Vref′ will be smaller, which leads to less discharge. Therefore, the setting of the compensation signal Vcomp enables more discharging and less charging of the energy storage unit 22 once its voltage Vc exceeds the high voltage threshold VH1.

Similarly, when the voltage Vc of the energy storage unit 22 drops to the low voltage threshold VL1, it represents that the voltage of the energy storage unit 22 is about to be discharged to the minimum limit. If the energy storage module 20 is in the discharging mode at this time, the energy storage unit 22 is easily over-discharged, that is, the voltage Vc of the energy storage unit 22 is lower than the minimum limit, which is undesirable. If the energy storage module 20 is in the charging mode at this time, the energy storage unit 22 is charged normally, but since the energy storage unit 22 has a small amount of energy at this time, it is of course desirable for it to store more energy. Therefore, when the voltage Vc of the energy storage unit 22 reaches the low voltage threshold VL1, less discharging and more charging of the energy storage unit 22 is achieved by using the compensation signal Vcomp. Those skilled in the art should understand that the principle is similar to the above, so the present disclosure will not repeat it.

Incidentally, when the voltage Vc of the energy storage unit 22 is greater than the high voltage threshold VH1, a change rate of the compensation signal Vcomp with respect to the voltage Vc of the energy storage unit 22 is a first change rate. When the voltage Vc of the energy storage unit 22 is less than the low voltage threshold VL1, a change rate of the compensation signal Vcomp with respect to the voltage Vc of the energy storage unit 22 is a second change rate. In particular, the first change rate and the second change rate may be the same, or the first change rate may be greater than the second change rate, or the first change rate may be less than the second change rate.

In addition, in this embodiment, when the voltage Vc of the energy storage unit 22 is between the low voltage threshold VL1 and the high voltage threshold VH1, the compensation signal Vcomp is zero. Therefore, no additional control is required for the charging and discharging of the energy storage unit 22 at this stage.

Furthermore, since the compensation signal Vcomp increases as the voltage Vc of the energy storage unit 22 increases, when the voltage Vc of the energy storage unit 22 increases from the high voltage threshold VH1 to the second high voltage threshold VH2, the adjusted reference signal Vref can decrease to be exactly zero, such that the energy storage module 20 exits the charging mode. Moreover, since the compensation signal Vcomp gradually increases, the adjusted reference signal Vref also gradually decreases to zero, and thus the energy storage module 20 slowly exits the charging mode. Similarly, when the voltage Vc of the energy storage unit 22 decreases from the low voltage threshold VL1 to the second low voltage threshold VL2, the adjusted reference signal Vref can increase to be just equal to the rated value of the current-sharing bus sampling signal Vsamp, such that the energy storage module 20 exits the discharge mode. Furthermore, since the compensation signal Vcomp gradually decreases, the adjusted reference signal Vref gradually increases to the rated value of the current-sharing bus sampling signal Vsamp, and thus the energy storage module 20 slowly exits the discharge mode. In particular, the rated value of the current-sharing bus sampling signal Vsamp represents the output current of the power module 10 at rated power. Therefore, the setting of the compensation signal Vcomp may also achieve a soft exit for the energy storage module 20.

The second embodiment is shown in FIG. 7, which is a schematic diagram of a relationship between the compensation signal and the voltage of the energy storage unit according to another embodiment of the present disclosure. When the voltage Vc of the energy storage unit 22 is greater than the high voltage threshold VH1, the compensation signal Vcomp is a positive value; when the voltage Vc of the energy storage unit 22 is less than the low voltage threshold VL1, the compensation signal Vcomp is a negative value. Specifically, when the voltage Vc of the energy storage unit 22 is greater than the high voltage threshold VH1, the compensation signal Vcomp is positively correlated with the voltage Vc of the energy storage unit 22, that is, the compensation signal Vcomp increases with the increase of the voltage Vc of the energy storage unit 2. Similarly, when the voltage Vc of the energy storage unit 22 is less than the low voltage threshold VL1, the compensation signal Vcomp is positively correlated with the voltage Vc of the energy storage unit 22, that is, the compensation signal Vcomp decreases with the decrease of the voltage Vc of the energy storage unit 22. Furthermore, the positive correlation between the compensation signal Vcomp and the voltage Vc of the energy storage unit 22 may be a linear relationship.

Incidentally, when the voltage Vc of the energy storage unit 22 is greater than the high voltage threshold VH1, a change rate of the compensation signal Vcomp with respect to the voltage Vc of the energy storage unit 22 is a first change rate. When the voltage Vc of the energy storage unit 22 is less than the low voltage threshold VL1, a change rate of the compensation signal Vcomp with respect to the voltage Vc of the energy storage unit 22 is a second change rate. In particular, the first change rate and the second change rate may be the same, or the first change rate may be greater than the second change rate, or the first change rate may be less than the second change rate.

The setting method and compensation principle of the compensation signal Vcomp are the same as those in the previous embodiment, so no further elaboration will be made. The difference between this embodiment and the previous embodiment is that when the voltage of the energy storage unit 22 is between the low voltage threshold VL1 and the high voltage threshold VH1, the compensation signal Vcomp is also positively correlated with the voltage Vc of the energy storage unit 22. In one embodiment, when the voltage Vc of the energy storage unit 22 is between the low voltage threshold VL1 and the high voltage threshold VH1, a change rate of the compensation signal Vcomp with respect to the voltage Vc of the energy storage unit 22 is a third change rate. In particular, the third change rate is less than the first change rate, and the third change rate is less than the second change rate.

As shown in FIG. 7, the first change rate is:

$$S 1 = \frac{( V comp 2 - V comp 1 )}{( V H 2 - V H 1 )} ,$$

where Vcomp2 and Vcomp 1 are positive values, Vcomp2 is greater than Vcomp1, VH2 and VH1 are positive values, VH2 is greater than VH1. The second change rate is:

$$S 2 = \frac{( V comp {2}^{′} - V comp {1}^{′} )}{( V L 2 - V L 1 )} ,$$

where Vcomp2′ and Vcomp1′ are negative values, Vcomp2′ is less than Vcom1, VL2 and VL1 are positive values, VL2 is less than VL1. The third change rate is:

$$S 3 = \frac{( V comp 1 - V comp {1}^{′} )}{( V H 1 - V L 1 )} ,$$

where Vcomp1 is a positive value, Vcomp1′ is a negative value, VH1 and VL1 are positive values, VH1 is greater than VL1. Therefore, S3 is less than S1 and S3 is less than S2. Additionally, S1 is equal to S2, greater than S2, or less than S2.

It should be understood that the voltage Vc of the energy storage unit 22 between the low voltage threshold VL1 and the high voltage threshold VH1 is the most common voltage range for normal operation. The setting of the compensation signal Vcomp may be applied to multiple energy storage modules 20 in parallel so that the energy storage module 20 with high capacitor voltage can discharge more and charge less and the energy storage module 20 with low capacitor voltage can charge more and discharge less, and therefore the capacitor voltages of multiple energy storage modules 20 are balanced. When the voltage Vc of the energy storage unit 22 is between the low voltage threshold VL1 and the high voltage threshold VH1, there is no need for fast adjustment, and fast adjustment is not conducive to system stability. Therefore, the third change rate may be set to a smaller value. When the voltage Vc of the energy storage unit 22 is less than the low voltage threshold VL1 or greater than the high voltage threshold VH1, at this time, it is desired that the voltage can be quickly adjusted to prevent it from exceeding the predetermined range.

Taking the charging of two energy storage modules as an example, the voltage of the first energy storage module is Vc1 and the voltage of the second energy storage module 20 is Vc2. If Vc2 is greater than Vc1, the compensation signal Vcomp_c2 of the second energy storage module is greater than the compensation signal Vcomp_c1 of the first energy storage module, such that the adjusted reference signal of the second energy storage module is less than the adjusted reference signal of the first energy storage module. Also based on the principle of FIG. 8, the second energy storage module charges less than before adjustment, while the first energy storage module charges more, thereby ultimately achieving voltage balancing between the two energy storage modules.

In summary, the present disclosure has the following features and advantages: based on less charging and more discharging when the energy storage module approaches the high voltage threshold to prevent overcharging, and based on less discharging and more charging when the energy storage module approaches the low voltage threshold to prevent over-discharging. Meanwhile, the present disclosure also enables soft exit for the energy storage modules and achieves voltage balancing in the energy storage units when multiple energy storage modules are connected in parallel.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A method of controlling an energy storage module, wherein the energy storage module comprises a bidirectional DC-to-DC converter and an energy storage unit, and a first terminal of the bidirectional DC-to-DC converter is connected to the energy storage unit, the method comprising: adjusting a reference signal according to a compensation signal, and acquiring a current reference signal corresponding to the bidirectional DC-to-DC converter according to the adjusted reference signal and a current-sharing bus signal provided by a power module connected to a second terminal of the bidirectional DC-to-DC converter to control an operation state of the energy storage module, wherein the compensation signal is determined by a voltage of the energy storage unit.

2. The method of controlling an energy storage module according to claim 1, wherein when the voltage of the energy storage unit is greater than a high voltage threshold, the compensation signal is a positive value; when the voltage of the energy storage unit is less than a low voltage threshold, the compensation signal is a negative value.

3. The method of controlling an energy storage module according to claim 1, further comprising: acquiring the adjusted reference signal based on a difference between the compensation signal and the reference signal.

4. The method of controlling an energy storage module according to claim 2, wherein the compensation signal is positively correlated with the voltage of the energy storage unit.

5. The method of controlling an energy storage module according to claim 2, wherein when the voltage of the energy storage unit is between the low voltage threshold and the high voltage threshold, the compensation signal is zero.

6. The method of controlling an energy storage module according to claim 2, wherein when the voltage of the energy storage unit is between the low voltage threshold and the high voltage threshold, the compensation signal is positively correlated with the voltage of the energy storage unit.

7. The method of controlling an energy storage module according to claim 6, wherein a change rate of the compensation signal with respect to the voltage of the energy storage unit when the voltage of the energy storage unit is between the low voltage threshold and the high voltage threshold is less than a change rate of the compensation signal with respect to the voltage of the energy storage unit when the voltage of the energy storage unit is greater than the high voltage threshold or less than the low voltage threshold.

8. The method of controlling an energy storage module according to claim 4, wherein the compensation signal is linearly related to the voltage of the energy storage unit.

9. The method of controlling an energy storage module according to claim 6, wherein the compensation signal is linearly related to the voltage of the energy storage unit.

10. The method of controlling an energy storage module according to claim 2, further comprising: configuring the adjusted reference signal to decrease to be zero when the voltage of the energy storage unit is greater than the high voltage threshold and continuously to increase to reach a second high voltage threshold, such that the energy storage module exits a charging mode.

11. The method of controlling an energy storage module according to claim 2, further comprising: configuring the adjusted reference signal to increase to be equal to a rated value of a current-sharing bus sampling signal when the voltage of the energy storage unit is less than the low voltage threshold and continuously to decrease to reach a second low voltage threshold, such that the energy storage module exits a discharging mode, wherein the current-sharing bus sampling signal is acquired by sampling the current-sharing bus signal, and the rated value of the current-sharing bus sampling signal represents an output current of the power module at rated power.

12. The method of controlling an energy storage module according to claim 1, wherein the reference signal represents an average power of the power module.

13. The method of controlling an energy storage module according to claim 12, wherein the reference signal is determined by the current-sharing bus signal.

14. The method of controlling an energy storage module according to claim 1, further comprising: generating a control signal to control the bidirectional DC-to-DC converter according to the current reference signal and an inductor current sampling signal of the bidirectional DC-to-DC converter.

15. The method of controlling an energy storage module according to claim 1, further comprising: acquiring a current-sharing bus sampling signal by sampling the current-sharing bus signal; controlling the energy storage module to operate in a discharging mode so that the energy storage unit discharges to a load of the power module when the current-sharing bus sampling signal is greater than a difference between the reference signal and the compensation signal; controlling the energy storage module to operate in a charging mode so that the energy storage unit stores energy when the current-sharing bus sampling signal is less than the difference between the reference signal and the compensation signal, thereby compensating for fluctuations of the input current of the power module.

16. A energy storage module comprising:
a bidirectional DC-to-DC converter and an energy storage unit, wherein a first terminal of the bidirectional DC-to-DC converter is connected to the energy storage unit, and a second terminal of the bidirectional DC-to-DC converter is connected to an output terminal of a power module; and
a controller, configured to execute the method in claim 1.

17. A power supply system comprising:
at least one power module, wherein an output terminal of each power module is connected in parallel to a load, and each power module is configured to convert its own output current into a voltage signal to a current-sharing bus, and
at least one energy storage module, each energy storage module having an output terminal connected together, and each energy storage module comprising a bidirectional DC-to-DC converter and an energy storage unit, wherein a first terminal of the bidirectional DC-to-DC converter is connected to the energy storage unit, and a second terminal of the bidirectional DC-to-DC converter is connected to the output terminal of the power module, and each energy storage module further comprises a controller, configured to execute the method in claim 1; wherein the voltage signal on the current-sharing bus is the current-sharing bus signal.

18. The power supply system as claimed in claim 17, wherein the at least one power module is disposed in the same power shelf.

19. The power supply system as claimed in claim 17, wherein the at least one energy storage module is disposed in the same power shelf.
